(19) United States
(12) Patent Application Publication
(10) Pub. No.: US 2015/0319335 A1
(43) Pub. Date: Nov. 5, 2015

(54) IMAGE PROCESSING APPARATUS, IMAGE PROCESSING METHOD, AND RECORDING MEDIUM STORING AN IMAGE PROCESSING PROGRAM

(71) Applicants: Hiroyuki BABA, Kanagawa (JP); Kazunari TONAMI, Kanagawa (JP)

(72) Inventors: Hiroyuki BABA, Kanagawa (JP); Kazunari TONAMI, Kanagawa (JP)

(21) Appl. No.: 14/689,232

(22) Filed: Apr. 17, 2015

(30) Foreign Application Priority Data
Apr. 30, 2014 (JP) 2014-093989

(51) Int. Cl. H04N 1/387; H04N 1/409; H04N 1/047; H04N 1/00

(52) U.S. Cl. CPC H04N 1/3878; H04N 1/00005; H04N 1/00082; H04N 1/409; H04N 1/047; H04N 1/00718; H04N 1/00774; H04N 2201/0094

(57) ABSTRACT

An image processing apparatus includes a data receiver that receive scanned image data acquired by scanning an image on a document, a plurality of document end detectors that detect an end of the document in the scanned image data using either different end detection methods or the same end detection method under different detection conditions to output end data for each detection method, a first skew calculator for each method that calculates skew of the scanned image data separately based on the end data for each method and output skew data for each method, and a second skew calculator that calculates skew of the scanned image data based on the skew data for each method.

### CROSS-REFERENCE TO RELATED APPLICATION

This patent application is based on and claims priority pursuant to 35 U.S.C. §119(a) to Japanese Patent Application No. 2014-093989, filed on Apr. 30, 2014 in the Japan Patent Office, the entire disclosure of which is hereby incorporated by reference herein.

### BACKGROUND

1. Technical Field

The present invention relates to an image processing apparatus, an image processing method, and a non-transitory recording medium storing an image processing program.

2. Background Art

Recently, along with digitization of information, image data is acquired by scanning images on documents using image scanners and the digitized image data is managed.

However, in scanning image data of documents using the image scanner, in case of mounting an automatic document feeder on the image scanner and scanning multiple pages of documents by feeding the documents sequentially, some images may be skewed due to skewing of the document.

To cope with this issue, a technology that mechanically corrects skew of documents transferred by the automatic document feeder is known in the art.

However, the mechanism that corrects the document skew mechanically in the automatic document feeder is loud, and it is difficult to meet quietness standards that contemporary apparatuses are supposed to satisfy.

To cope with this issue, a technology that detects the skew of the scanned image data and corrects the skew by image processing is known in the art.

Recently, an image scanner that includes a detector that detects a document size, an image scanning unit that illuminates a part of the document to be scanned with light and scans the scanned image using the reflected light, and an skew correction unit that scans a border between a document image corresponding to the document and a background image corresponding to areas other than the document on the scanned image within a range based on the document size detected by the detector and corrects the skew of the document image in the scanned image based on an angle between the border and the document transferring direction has been proposed.

That is, after detecting the document size, the skew angle is detected by scanning the border between the document image corresponding to the document and the background image corresponding to the area other than the document on the scanned image within the document size.

### SUMMARY

An example embodiment of the present invention provides a novel image processing apparatus that includes a data receiver that receives scanned image data acquired by scanning an image on a document, a plurality of document end detectors that detect an end of the document in the scanned image data using either different end detection methods or the same end detection method under different detection conditions to output end data for each detection method, a first skew calculator for each method that calculates skew of the scanned image data separately based on the end data for each method and output skew data for each method, and a second skew calculator that calculates skew of the scanned image data based on the skew data for each method.

Further example embodiments of the present invention provide an image processing method, and a non-transitory recording medium storing an image processing program.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a perspective diagram illustrating an appearance of a multifunction peripheral as an embodiment of the present invention.

FIG. 2 is a block diagram illustrating a hardware configuration of the multifunction peripheral as an embodiment of the present invention.

FIG. 3 is a block diagram illustrating main functions of the multifunction peripheral as an embodiment of the present invention.

FIGS. 4A to 4D are diagrams illustrating a process of detecting and correcting image data skew as an embodiment of the present invention.

FIG. 5 is a diagram illustrating a process of detecting a document end as an embodiment of the present invention.

FIG. 6 is a flowchart illustrating a process of detecting and correcting image data skew as an embodiment of the present invention.

FIGS. 7A to 7C are diagrams illustrating a process of detecting a document end based on brightness as an embodiment of the present invention.

FIGS. 8A and 8B are diagrams illustrating a process of detecting a document end based on brightness difference as an embodiment of the present invention.

FIGS. 9A and 9B are diagrams illustrating a process of detecting a document end based on color difference as an embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In the art, since the document skew is detected after detecting the document size, it is desirable to enhance detection accuracy of the document skew angle.

That is, in detecting the document size, it is impossible to avoid error in detecting the border between the document image and the background image in areas other than the document due to causes other than dust and vertical streaks, resulting in error in detecting an angle of document skew.

In the following embodiment, an image processing apparatus that can determine the document skew precisely is provided.

### First Embodiment

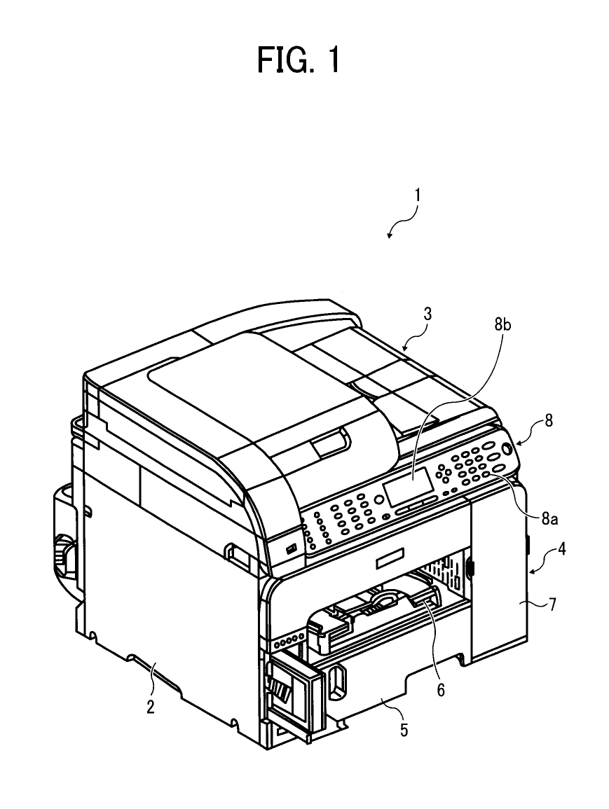

FIG. 1 is a perspective diagram illustrating an appearance of a multifunction peripheral in this embodiment.

In FIG. 1, in a multifunction peripheral (image scanner) 1, a scanning unit 3 is disposed on a main body 2, and a printing unit 4, a sheet feeding unit 5, a paper ejection unit 6, and an ink cartridge holder 7 etc. are included in the main body 2.

On the multifunction peripheral 1, there is a control panel 8 on the upper front of the main body 2. There are various keys 8a and a display (reporting unit) 8b on the control panel 8. On the control panel 8, various instructions on operating the multifunction peripheral 1 etc. are input using the keys 8a, and the display 8b displays content input by the keys 8a and various information that the multifunction peripheral 1 reports to a user.

A scanner that uses a photoelectric transducer such as Charge Coupled Device (CCD) or Complementary Metal Oxide Semiconductor (CMOS) is used as the scanning unit (image scanning unit) 3 and performs an image scanning process that scans a document and reads an image on the document.

For example, an inkjet printer is used as the printing unit 4, and a recording head on which nozzles that eject ink droplets in various colors are formed is included in the printing unit 4. The printing unit 4 forms images on a sheet conveyed from the sheet feeding unit 5 by ejecting ink droplets from the nozzles based on image data of the document scanned by the scanning unit 3 and image data transferred by external host apparatuses such as computers etc. via a wired/wireless network. After forming images, the printing unit 4 ejects the sheet on which the images are formed to the paper ejection unit 6.

The sheet feeding unit 5 includes multiple sheet feeding trays, and each sheet feeding tray can contain recording medium such as sheets in different sizes and films etc. (hereinafter referred to as sheet). The sheet feeding unit 5 conveys a sheet one by one to the printing unit 4 from a specified sheet feeding tray.

The ink cartridge holder 7 holds the ink cartridge in various colors and supplies ink liquid in the ink cartridge to the nozzles on the recording head in the printing unit 4.

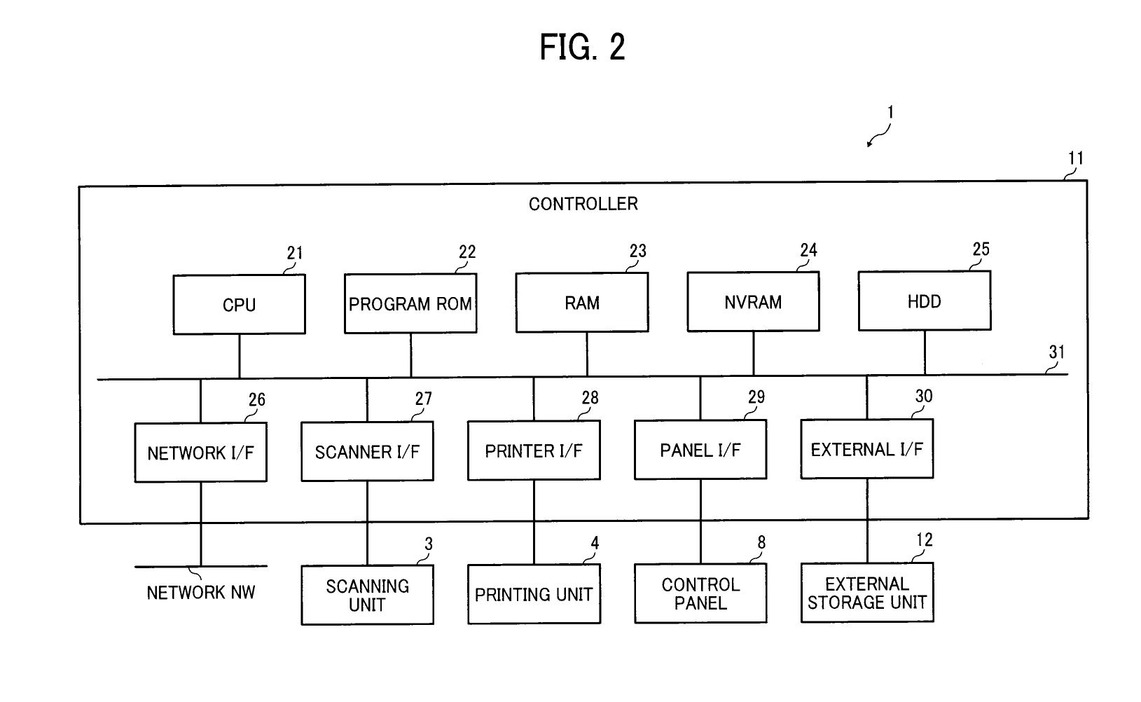

As shown in FIG. 2, the multifunction peripheral 1 consists of functional blocks and includes a controller 11, an external storage unit 12, the scanning unit 3, the printing unit 4, and the control panel 8 described above.

The Controller 11 includes units such as a Central Processing Unit (CPU) 21, a program Read Only Memory (ROM) 22, a Random Access Memory (RAM) 23, a Non-Volatile Random Access Memory (NVRAM) 24, a hard disk drive (HDD) 25, a network interface (I/F) 26, a scanner I/F 27, a printer I/F 28, a panel I/F 29, and an external I/F 30 etc., and those units are connected with each other via a bus 31.

The network I/F 26 is connected to host apparatuses such as computers via a network NW such as a Local Area Network (LAN), and the network I/F 26 receives control signals and image data etc. transferred by the host apparatus. In addition, the network I/F 26 sends out a status signal etc. that the multifunction peripheral 1 transfers to the host apparatus.

The program ROM 22 stores a program for processing and managing data in the controller 11 and controlling peripheral modules. More specifically, the program ROM 22 stores various programs such as an operating system of the multifunction peripheral 1 and an image processing program that executes a document skew detecting process in this embodiment. The program ROM 22 also stores various data for executing those programs.

The CPU 21 controls each unit in the multifunction peripheral 1, executes image processing such as printing and transferring, and executes image processing methods in this embodiment in this embodiment using the RAM 23 as a work memory based on the programs stored in the program ROM 22.

The RAM 23 is used as a work memory by the CPU 21. In addition, the RAM 23 is used as a buffer that stores image data managed in units of a page temporarily and a bitmap memory that the data stored in the buffer is converted into drawing data appropriate to actual printing and expanded.

The NVRAM 24 keeps stored data even if the power of the multifunction peripheral 1 is down and stores data to be kept while the power of the multifunction peripheral 1 is down and especially various data used in an image processing (described later) under the control of the CPU 21.

The HDD 25 stores and sends out data such as image data of the document scanned by the scanning unit 3 and image data transferred by the host apparatus etc. under the control of the CPU 21.

The scanner I/F 27 is connected to the scanning unit 3 described above. The scanner I/F 27 transfers a control signal from the controller 11 to the scanning unit 3 and a status signal and image data of the scanned document from the scanning unit 3 to the controller 11.

The printer I/F 28 is connected to the printing unit 4 described above. The printer I/F 28 transfers a control signal from the controller 11 to the printing unit 4 and a status signal from the printing unit 4 to the controller 11.

The panel I/F 29 is connected to the control panel 8 described above. The panel I/F 29 transfers signals and data from the CPU 21 to the control panel 8 and vice versa.

The external I/F 30 is connected to the portable external storage unit 12 detachably. For example, a Universal Serial Bus (USB) memory, a memory card (e.g., SD memory card), and a flexible disk can be inserted as the external storage unit 12. The external I/F 30 drives the external storage unit 12 under the control of the CPU 21, reads data stored in the external storage unit 12, and writes data in the external storage unit 12. The external I/F 30 detects that the external storage unit 12 is inserted into the external I/F 30 or the external storage unit 12 is removed from the external I/F 30 automatically and outputs the detection result to the CPU 21.

The multifunction peripheral 1 is constructed as an image processing apparatus that executes an image processing method (described later) that detects the document skew in the scanned image data acquired by scanning the image of the document precisely by reading an image processing program that executes the image processing method in this embodiment stored in a computer-readable recording medium such as the ROM, Electrically Erasable and Programmable Read Only Memory (EEPROM), flash memory, flexible disk, Compact Disc Read Only Memory (CD-ROM), Compact Disc Rewritable (CD-RW), Digital Versatile Disc (DVD), Secure Digital (SD) card, and Magneto-Optical Disc (MO) etc. The image processing program is a computer-executable program written in legacy programming languages and object-oriented programming languages such as assembler, C, C++, C#, and Java etc., and the power supply control program can be distributed by storing in the recording medium described above.

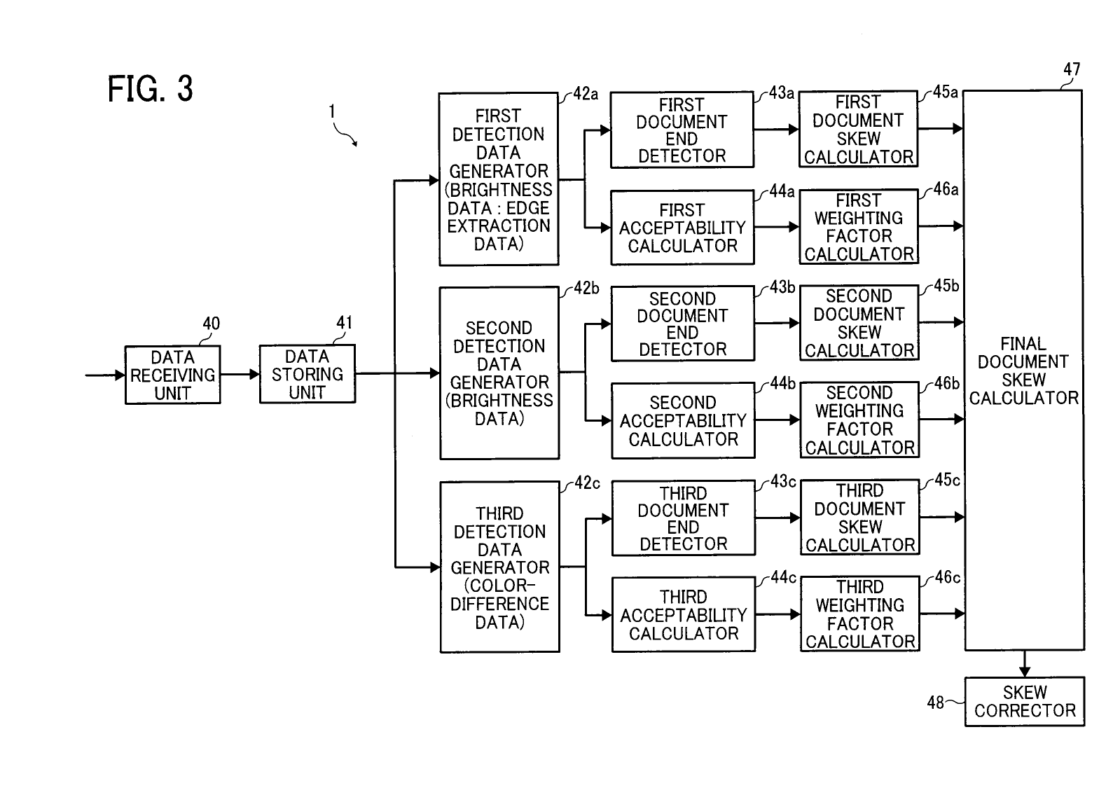

In the multifunction peripheral 1, functional blocks in FIG. 3 are implemented by installing and executing the image processing program described above. That is, in the multifunction peripheral 1, a data receiving unit 40, a data storing unit 41, a first detection data generator 42a, a second detection data generator 42b, a third detection data generator 42c, a first document end detector 43a, a second document end detector 43b, a third document end detector 43c, a first acceptability calculator 44a, a second acceptability calculator 44b, a third acceptability calculator 44c, a first document skew calculator 45a, a second document skew calculator 45b, a third document skew calculator 45c, a first weighting factor calculator 46a, a second weighting factor calculator 46b, a third weighting factor calculator 46c, a final document skew calculator 47, and an skew corrector 48 are implemented by installing the image processing program. In the multifunction peripheral 1, the functional blocks described above are implemented in the controller 11 by installing the image processing program described above, and the controller 11 functions as the image processing apparatus. As a result, the multifunction peripheral 1 functions as the image scanner that includes the scanning unit 3 as an image scanning unit and the controller 11 as the image processing apparatus (an image processor).

The data receiving unit 40 implemented by the scanner I/F 27 and the network I/F 26 etc., receives scanned image data that the scanning unit 3 scans or the host apparatus scans, and stores the scanned image data in the data storing unit 41.

The data storing unit 41 consists of the HDD 25 etc. and stores the scanned image data that the data receiving unit 40 receives for each page.

Each of the detection data generators (data generating units) 42a, 42b, and 42c generates formatted data (data to be processed for each method) in a format compatible with end detecting methods employed by the document end detectors 43a, 43b, and 43c (described later) corresponding to the scanned image data that the data receiving unit 40 receives.

Here, it is assumed that the first document end detector 43a adopts an end detection method that detects document end based on brightness data (edge extraction level) and the second document end detector 43b adopts an end detection method that detects document end based on brightness difference (density difference). It is also assumed that the third document end detector 43c adopts an end detection method that detects document end based on color difference.

Assuming that the end detection methods described above are adopted, the first detection data generator 42a generates brightness data, especially edge detection data, as target data to be processed for each method from the scanned image data and outputs it to the first document end detector 43a and the first acceptability calculator 44a. In addition, the second detection data generator 42b generates brightness difference data as target data to be processed for each method from the scanned image data and outputs it to the second document end detector 43b and the second acceptability calculator 44b. Furthermore, the third detection data generator 42c generates color difference data as target data to be processed for each method from the scanned image data and outputs it to the third document end detector 43c and the third acceptability calculator 44c. For example, if the scanned image data is R (red), G (green), and B (blue) data, the third detection data generator 42c generates Lab data converting the RGB data into Lab space and generates color difference data using the Lab data.

Based on the brightness data generated by the first detection data generator 42a, the first document end detector (a document end detecting unit) 43a detects end positions of the scanned image data, especially two upper end positions, and outputs the detected two end position data to the first document skew calculator 45a. In the above description, the first document edge detector 43a detects two upper ends separated by predetermined distance in the scanned image data. However, the detected positions are not limited in upper ends. In addition, the number of detected positions is not limited to two.

The first acceptability calculator (a acceptability calculating unit) 44a calculates acceptability of detecting document edges in the end detection method of the first document end detector 43a based on the edge detection data (brightness data) and outputs the calculated acceptability to the first weighting factor calculator 46a.

Based on the brightness difference data generated by the second detection data generator 42b, the second document end detector (a document end detecting unit) 43b detects end positions of the scanned image data, especially two upper end positions, and outputs the detected two end position data to the second document skew calculator 45b. In the above description, the second document edge detector 43b detects two upper ends separated by predetermined distance in the scanned image data. However, the detected positions are not limited in upper ends. In addition, the number of detected positions is not limited to two.

The second acceptability calculator (a acceptability calculating unit) 44b calculates acceptability of detecting document edges in the end detection method of the second document end detector 43b based on the brightness difference data and outputs the calculated acceptability to the second weighting factor calculator 46b.

The third acceptability calculator (a acceptability calculating unit) 44c calculates acceptability of detecting document edges in the end detection method of the third document end detector 43c based on the color difference data and outputs the calculated acceptability to the third weighting factor calculator 46c.

Based on the color difference data generated by the third detection data generator 42c, the third document end detector (a document end detecting unit) 43c detects end positions of the scanned image data, especially two upper end positions, and outputs the detected two end position data to the third document skew calculator 45c. In the above description, the third document edge detector 43c detects two upper ends separated by predetermined distance in the scanned image data. However, the detected positions are not limited in upper ends. In addition, the number of detected positions is not limited to two.

The first document skew calculator (an skew calculating unit for each method) 45a calculates skew of the scanned image data as a first document skew based on the end position data input by the first document end detector 43a and outputs the calculated first document skew to the final document skew calculator 47.

The first weighting factor calculator (a weighting factor calculating unit) 46a calculates weighting factor of the first document skew calculated by the first document skew calculator 45a based on the acceptability input by the first acceptability calculator 44a and outputs it as a first weighting factor to the final document skew calculator 47.

The second document skew calculator (an skew calculating unit for each method) 45b calculates skew of the scanned image data as a second document skew based on the end position data input by the second document end detector 43b and outputs the calculated second document skew to the final document skew calculator 47.

The second weighting factor calculator (a weighting factor calculating unit) 46b calculates weighting factor of the second document skew calculated by the second document skew calculator 45b based on the acceptability input by the second acceptability calculator 44b and outputs it as a second weighting factor to the final document skew calculator 47.

The third document skew calculator (an skew calculating unit for each method) 45c calculates skew of the scanned image data as a third document skew based on the end position data input by the third document end detector 43c and outputs the calculated third document skew to the final document skew calculator 47.

The third weighting factor calculator (a weighting factor calculating unit) 46c calculates weighting factor of the third document skew calculated by the third document skew calculator 45c based on the acceptability input by the third acceptability calculator 44c and outputs it as a third weighting factor to the final document skew calculator 47.

The final document skew calculator (an skew calculating unit) 47 calculates skew of the scanned image data as final document skew based on the first document skew, the first weighting factor, the second document skew, the second weighting factor, the third document skew, and the third weighting factor and outputs the calculated final document skew to the skew corrector 48.

The skew corrector (a skew correcting unit) 48 corrects the skew of the scanned image data based on the final document skew.

Next, workings in this embodiment are described below. The multifunction peripheral 1 in this embodiment detects skew of scanned image data precisely without detecting using hardware.

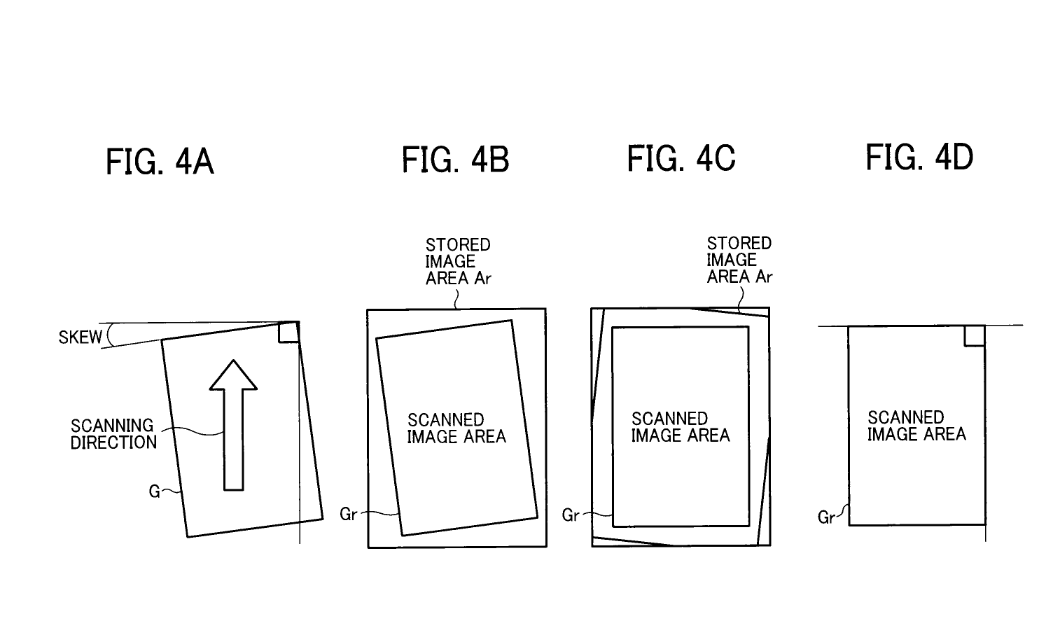

That is, after the data receiving unit 40 receives the scanned image data, the multifunction peripheral 1 stores it in the data storing unit 41, detects skew of the stored scanned image data as shown in FIGS. 4A to 4D, and corrects skew based on the detection result. As shown in FIG. 4A, in the multifunction peripheral 1, it is assumed that a document G is scanned with some skew against the scanning direction by the scanning unit 3 or a scanner in the host apparatus. In the multifunction peripheral 1, the data receiving unit 40 receives the scanned image data of the document with some skew, and the scanned image data is stored in the data storing unit for each page.

Since the scanned image data includes skew, in the multifunction peripheral 1, as shown in FIG. 4B, the scanned image data indicated by a scanned image area Gr is stored in a stored image area Ar larger than the scanned image area Gr as the image area of the scanned image data since the scanned image data includes skew.

The multifunction peripheral 1 detects skew of the scanned image data (the scanned image area Gr) stored in the stored image area Ar, and as shown in FIG. 4C, the multifunction peripheral 1 corrects the scanned image data (the scanned image area Gr) on the stored image area Ar.

As shown in FIG. 4D, the multifunction peripheral 1 clips image data of the scanned image area Gr in the stored image area Ar and prints out and transfers the clipped image data.

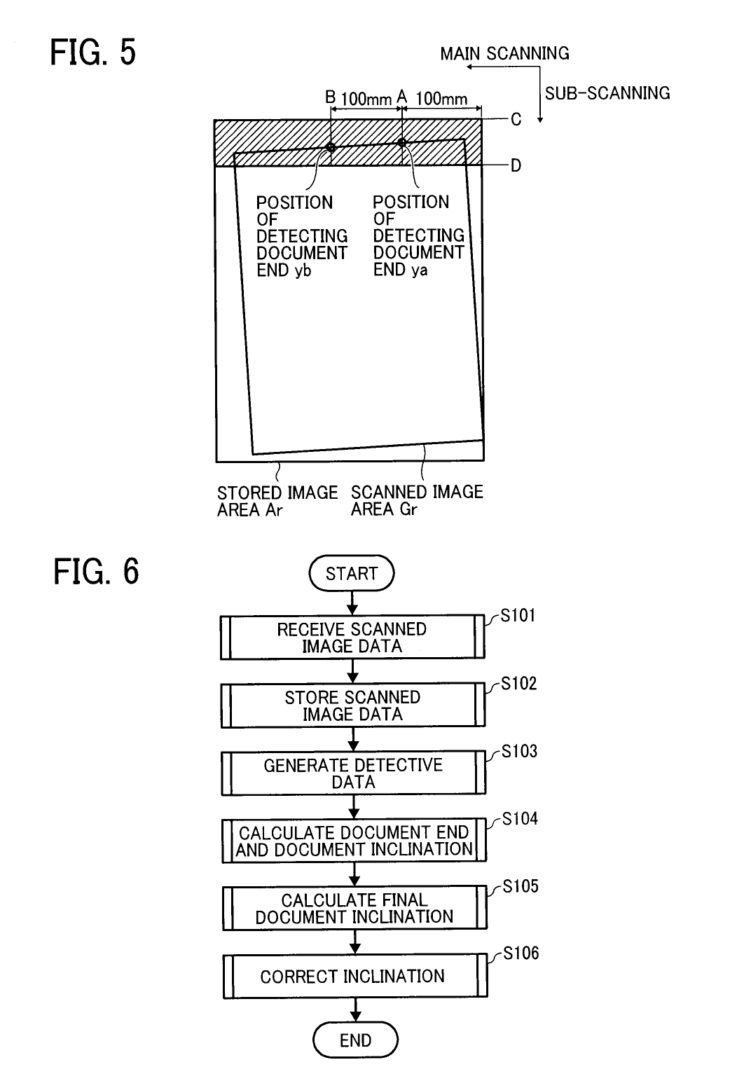

As shown in FIG. 5, in order to detect skew of the scanned image data quickly with less data processing, the multifunction peripheral 1 detects skew of the scanned image data by detecting skew against the upper end of the stored image area Ar in the upper end of the scanned image area Gr.

That is, for example, the multifunction peripheral 1 detects end positions in the sub-scanning direction (vertical direction in FIG. 5) at two points with predetermined distance away from the upper right corner of the scanned image area Gr, 100 mm away from the upper right corner (a detection point A) and 200 mm away from the upper right corner (a detection point B) in FIG. 5. In addition, in order to detect skew of the scanned image data quickly with less data processing, the multifunction peripheral 1 detects the document end scanning from an upper end C of the stored image area Ar to the lower check limit position D in the sub-scanning direction as a check area. In addition, the multifunction peripheral 1 acquires the position where the document end I detected acquiring distance from the upper end of the stored image area Ar to the upper end of the scanned image area Gr as document end position data ya and yb and calculates the document skew. As a result, by performing data processing within the check area only, it is possible to detect skew of the scanned image data and speed up processing.

More specifically, the multifunction peripheral 1 performs an image processing that detects and corrects skew as shown in FIG. 6. That is, as shown in FIG. 6, in the multifunction peripheral 1, the data receiving unit 40 receives scanned image data from the scanning unit 3 or the host apparatus in S101.

Next, in the multifunction peripheral 1, the received scanned image data is stored in the stored image area Ar in the data storing unit 41 as shown in FIG. 4B in S102.

After that, in the multifunction peripheral 1, the detection data generators 42a to 42c generate detection data in accordance with the processing methods of document end detection by the document end detectors 43a to 43c in S103.

For example, the first document end detector 43a detects the document end based on detecting the document end (edge) using an edge extraction filter such as a Sobel filter, etc. Subsequently, the first detection data generator 42a corresponding to the first document end detector 43a generates brightness data, especially edge extraction data, as the detection data from the scanned image data. The brightness data described above is gray information generated from RGB in the scanned image data and L data performed color conversion to Lab. Since the second document end detector 43b detects the document end based on the brightness difference, the second detection data generator 42b corresponding to the second document end detector 43b generates brightness data as the detection data from the scanned image data. Furthermore, since the third document end detector 43c detects the document end based on the color difference of the image data, the third detection data generator 42c corresponding to the third document end detector 43c generates the color difference data from the scanned image data. Subsequently, the detection data generators 42a to 42c output the generated detection data to the corresponding document end detectors 43a to 43c and the corresponding acceptability calculators 44a to 44c.

Next, in the multifunction peripheral 1, the document end detectors 43a to 43c, the acceptability calculators 44a to 44c, the document skew calculators 45a to 45c, and the weighting factor calculators 46a to 46c calculates the document end and skew in S104. In calculating the document end and skew, it should be noted that document skew angle is calculated based on the detection result of the document end and the weighting factor is calculated in accordance with the acceptability. The detailed processing above is described later.

In the multifunction peripheral 1, the final document skew calculator 47 adjusts the document skew calculated by calculating the document end and skew based on the weighting factor and calculates the final document skew angle in S105.

In the multifunction peripheral 1, based on the final document skew angle, the skew corrector 48 corrects the skew of the scanned image data and clips the desired image data in S106.

Next, in the multifunction peripheral 1, the document end detectors 43a to 43c, the acceptability calculators 44a to 44c, the document skew calculators 45a to 45c, and the weighting factor calculators 46a to 46c perform a process described below.

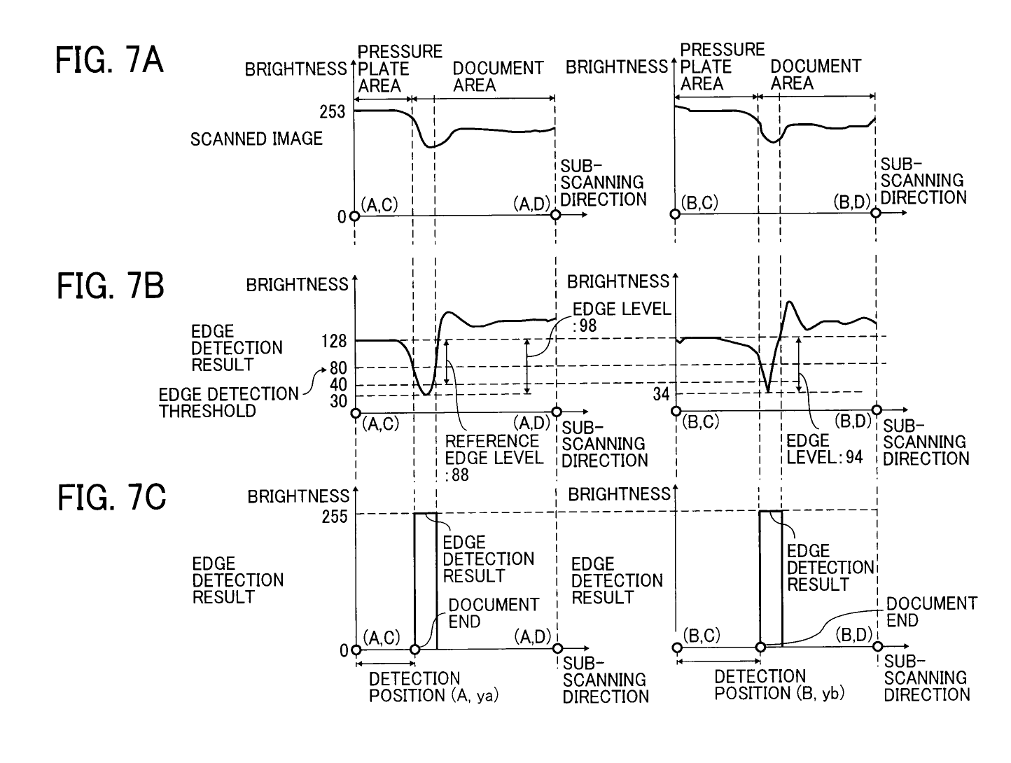

As shown in FIGS. 7A to 7C, the first document end detector 43a detects the document end position in the scanned image data based on the brightness data (the edge extraction data) as the first detection data input by the first detection data generator 42a. That is, among the scanned image data, as shown in FIG. 7A, the brightness data generated by the first detection data generator 42a is changed from the detection position A to the detection position B in the sub-scanning direction. Here, a pressure plate area in FIGS. 7A to 7C indicates a plate member disposed behind the document from the viewpoint of a scanning sensor in the document scanner such as the scanning unit 3. For example, that indicates a pressure plate in case of mounting the document on exposure glass and a guide plate etc. in case of feeding the document. Normally, while the pressure plate is colored in white, a slight data change appears in the scanned image data due to floating dusts and blot etc. Subsequently, after checking change of the brightness data generated from the scanned image data corresponding to the detection positions A and B, the first document end detector 43a extracts a shadow part of the document end as the edge element as shown in FIG. 7B. For example, the first document end detector 43a detects the edge using an edge extraction filter such as a Sobel filter and calculates the edge detection result by performing binarization on the data. Furthermore, as shown in FIG. 7C, the first document end detector 43a compares the edge detection result after the binarization with a predetermined threshold (e.g., 255) and determines areas whose results are equal to or lower than the threshold (255) as the edge part and variation points where the result changes from 0 to 255 as the document end. Regarding the number of lines from the top of the image to the edge variation point, the first document end detector 43a counts the document end ya at the detection position A as 100th line and the document end yb at the detection position B as 116th line and outputs the counting result as the document end positions to the first document skew calculator 45a.

After that, the first document skew calculator 45a calculates the first document skew d1 from the document end positions ya and yb at the detection positions A and B by the first document end detector 43a and the number of pixels ABs between the detection positions A and B using Equation (1) shown below. If it is assumed that ya is 100, yb is 116, and ABs is 2362, the first document skew d1 is calculated as about 0.39 degrees using Equation (1). It should be noted that it is assumed that the scanning resolution is 600 dpi in the main scanning direction and the sub-scanning direction in this embodiment.

d1=(ya−yb)/Abs

d1=(100-116)/2362=about 0.39 degrees Equation (1)

The first document skew calculator 45a outputs the calculated first document skew d1 to the final document skew calculator 47.

The first acceptability calculator 44a calculates acceptability of the document end detection method using the edge detection by the first document end detector 43a as a ratio between a level of peak position of the edge and a predetermined standard edge level. In detecting the edge, it is possible to detect the document edge precisely as the peak of the edge gets higher.

If the peak of the edge is low, it is possible that the first acceptability calculator 44a detects the floating dust or blot of the pressure plate. To cope with this issue, in this embodiment, for example, as shown in FIG. 7B, if it is assumed that the reference edge level is 88 and the edge level of the document end edge at the detection position A is 98, the first acceptability calculator 44a calculates the acceptability sa as 98/88 equals about 1.11. Similarly, if it is assumed that the first acceptability calculator 44a calculates the acceptability sb as 94/88 equals about 1.07.

The first acceptability calculator 44a outputs the calculated acceptability sa and sb to the first weighting factor calculator 46a.

The first weighting factor calculator 46a converts the acceptability input from the first acceptability calculator 44a into the weighting factor and outputs it to the final document skew calculator 47. More specifically, the first weighting factor calculator 46a calculates the weighting factor K1 using a simple average between the acceptability at the detection positions A and B, smaller one or larger one between the acceptability at the detection position A and the acceptability at the detection position B, or an average of the acceptability at the detection positions A and B multiplying a predetermined multiple.

For example, in case of using the simple average, the first weighting factor calculator 46a calculates K1 as (sa+sb)/2. In case of using the smaller one or the larger one, the first weighting factor calculator 46a calculates K1 as max(sa, sb) or min(sa, sb). In case of using the multiplied average, the first weighting factor calculator 46a calculates K1 as (sa*s+sb*s)/2. In the above equations, max( ) is a function that selects the maximum value, and min( ) is a function that selects the minimum value. In addition, s in sa*s and sb*s indicates a scaling factor.

Here, in case of using the multiplied average, if it is assumed that sa is 1.11, sb is 1.07, and s is 1.4, the weighting factor K1 is calculated as (1.11*1.4+1.07*1.4)/2 equals 1.526.

If the difference against a document background part is extremely large compared to the reference, it is possible that the first weighting factor calculator 46a saturates the weighting factor at a predetermined value limiting an upper value to prevent from weighting too much.

For example, in case of the upper limit of the acceptability is 1.10, the first weighting factor calculator 46a replaces 1.11 in the above example with 1.10.

By contrast, if the acceptability is extremely small, it is possible to detect wrongly. Therefore, the first weighting factor calculator 46a preset the lower limit of the acceptability and set the factor for 0 if the factor becomes smaller than the lower limit to minimize effectiveness of the wrong detection. For example, if it is assumed that sa is 1.11, sb is 0.8, and the lower limit is 0.9, the first weighting factor calculator 46a sets 0 for the weighting factor K1.

After that, the second document end detector 43b calculates the brightness difference from the brightness data generated by the second detection data generator 42b, detects the end positions in the scanned image data, especially the positions of the two upper ends, and outputs the detected two end position data to the second document skew calculator 45b.

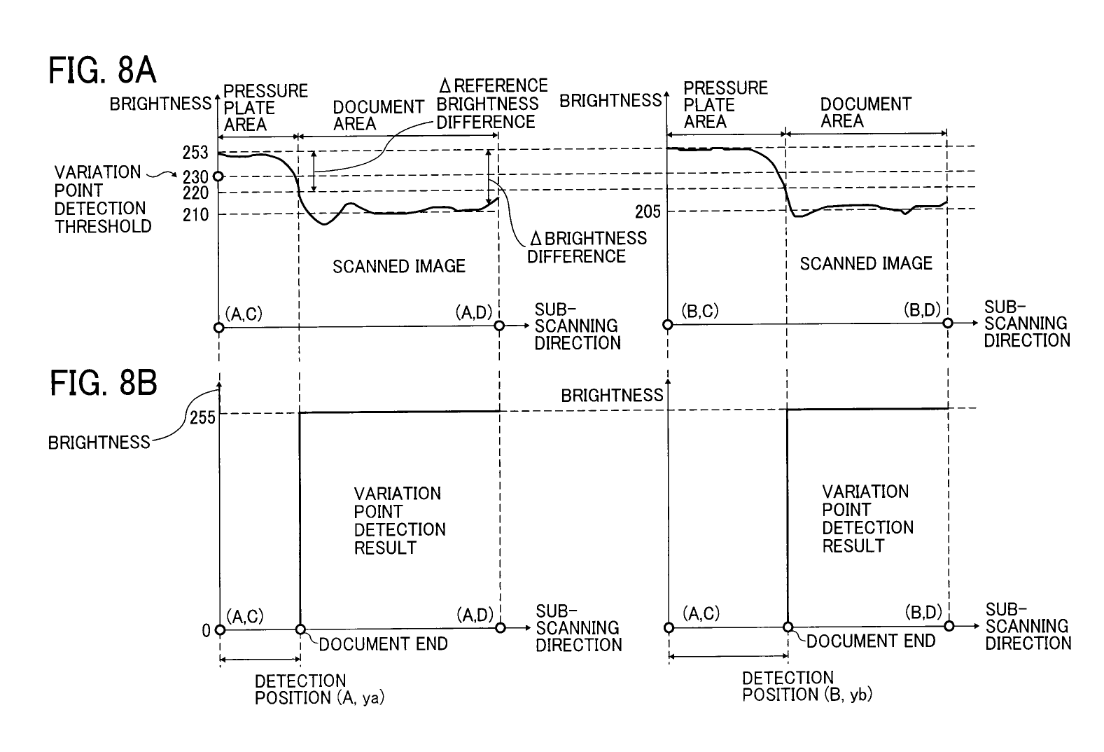

As shown in FIGS. 8A and 8B, the second document end detector 43b detects the document end position in the scanned image data based on the brightness data as the second detection data input by the second detection data generator 42b. That is, among the scanned image data, as shown in FIG. 8A, the brightness data generated by the second detection data generator 42b is changed from the detection position A to the detection position B in the sub-scanning direction. The second document end detector 43b detects the variation points between the brightness data of the pressure plate and the brightness data of the document background part before scanning the document part as the document end. The multifunction peripheral 1 stores an average value of scanned data of brightness of the pressure plate without dusts or blot at factory shipment etc. for example as reference for calculating the brightness difference by the second document end detector 43b. Here, in FIG. 8A, it is assumed that the brightness of the pressure plate is 253. The second document end detector 43b calculates the brightness of the document area by averaging pixel data after the variation point (described later).

In this case, in FIG. 8A, it is assumed that the brightness of the document area is 210 at the detection position A and 205 at the detection position B. In addition, the second document end detector 43b calculates the variation point by binarizing the brightness information of the scanned image data using the variation point detection threshold (230 in this embodiment).

That is, as shown in FIG. 8B, the second document end detector 43b detects the variation point where the binarized value changes from 0 into 255 as the document end. In FIG. 8B, the second document end detector 43b detects ya as 105th line as the detection position A and yb as 120th line as the detection position B and outputs the detection results to the second document skew calculator 45b.

The second document skew calculator 45b calculates the second document skew d2 from the document end positions ya and yb at the detection positions A and B by the second document end detector 43b and the number of pixels ABs between the detection positions A and B using Equation (2) shown below. If it is assumed that ya is 105, yb is 120, and ABs is 2362, the second document skew d2 is calculated as about 0.36 degrees using Equation (2).

d2=(ya−yb)/Abs

d2=(105−120)/2362=about 0.36 degrees Equation (2)

The second document skew calculator 45b outputs the calculated second document skew d2 to the final document skew calculator 47.

The second acceptability calculator 44b calculates acceptability of the document end detection method using the brightness difference by the second document end detector 43b as a ratio between brightness difference between the pressure plate area and the document area and a predetermined reference edge level. In detecting the document edge using the brightness difference, it is possible to detect the document edge as the brightness difference gets larger. If the brightness of the pressure plate is similar to the brightness of the document background area, it is possible to detect the document edge wrongly since the brightness difference is small.

For example, if it is assumed that the reference brightness difference is 33 and the brightness difference of the document background area at the detection position A is 43, the second acceptability calculator 44b in this embodiment calculates the acceptability sa as 43/33 equals about 1.3. Similarly, if it is assumed that the brightness difference of the document background area at the detection position B is 48, the second acceptability calculator 44b calculates sb as 48/33 equals about 1.45.

The second acceptability calculator 44b outputs the calculated acceptability sa and sb to the second weighting factor calculator 46b.

The second weighting factor calculator 46b converts the acceptability input from the second acceptability calculator 44b into the weighting factor and outputs it to the final document skew calculator 47. More specifically, the second weighting factor calculator 46b calculates the weighting factor K2 using a simple average between the acceptability at the detection positions A and B, smaller one or larger one between the acceptability at the detection position A and the acceptability at the detection position B, or an average of the acceptability at the detection positions A and B multiplying a predetermined multiple.

For example, in case of using the simple average, the second weighting factor calculator 46b calculates K2 as (sa+sb)/2. In case of using the smaller one or the larger one, the second weighting factor calculator 46b calculates K2 as max(sa, sb) or min(sa, sb). In case of using the multiplied average, the second weighting factor calculator 46b calculates K2 as (sa*s+sb*s)/2.

Here, in case of using the multiplied average, if it is assumed that sa is 1.30, sb is 1.45, and s is 1.5, the weighting factor K2 is calculated as (1.30*1.5+1.45*1.5)/2 equals 2.0625.

If the difference against a document background part is extremely large compared to the reference, it is possible that the second weighting factor calculator 46b saturates the weighting factor at a predetermined value limiting an upper value to prevent from weighting too much.

For example, in case of the upper limit of the acceptability is 1.30, the second weighting factor calculator 46b replaces 1.45 in the above example with 1.30.

By contrast, if the acceptability is extremely small, it is possible to detect wrongly. Therefore, the second weighting factor calculator 46b preset the lower limit of the acceptability and set the factor for 0 if the factor becomes smaller than the lower limit to minimize effectiveness of the wrong detection. For example, if it is assumed that sa is 0.85, sb is 1.45, and the lower limit is 0.9, the second weighting factor calculator 46b sets 0 for the weighting factor K2.

After that, based on the color difference data generated by the third detection data generator 42c, the third document end detector 43c detects the end positions in the scanned image data, especially the positions of the two upper ends, and outputs the detected two end position data to the third document skew calculator 45c.

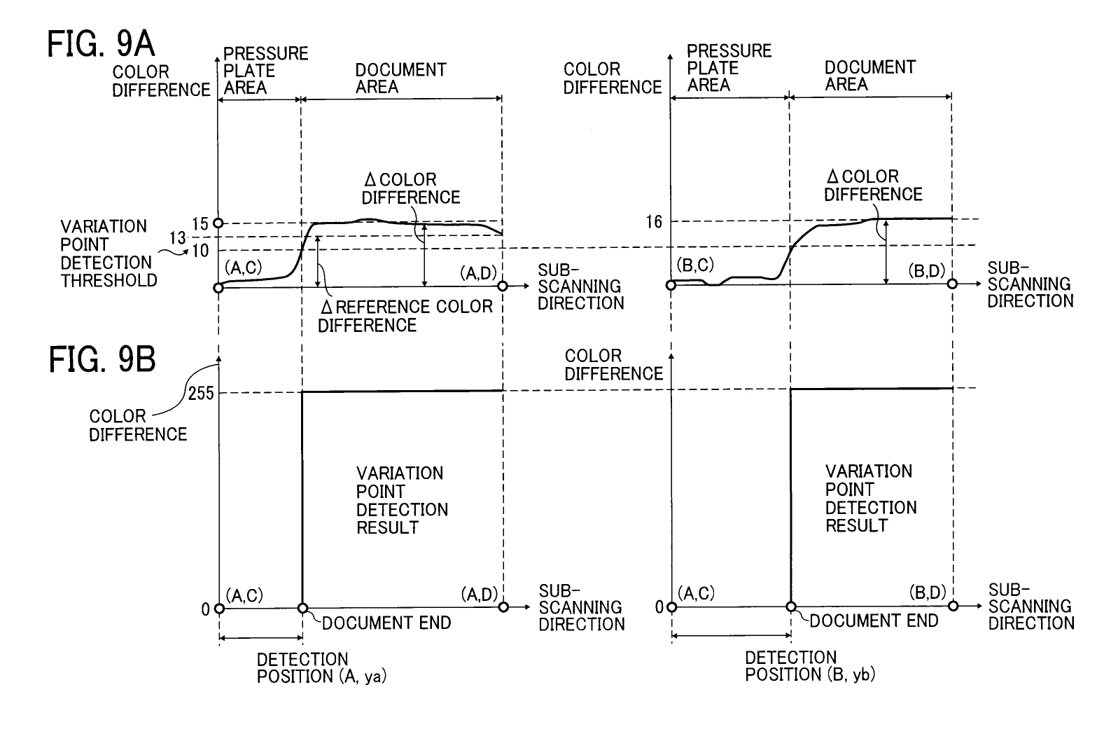

Here, as described above, the third detection data generator 42c generates the color difference data by performing color conversion from RGB of the scanned image data into Lab. In this case, the color difference data at the detection positions A and B and a conversion point of the color difference data are shown in FIGS. 9A and 9B.

As shown in FIGS. 9A and 9B, the third document end detector 43c detects the document end position in the scanned image data based on the color difference data as the third detection data input by the third detection data generator 42c. That is, among the scanned image data, as shown in FIG. 9A, the color difference data generated by the third detection data generator 42c is changed from the detection position A to the detection position B in the sub-scanning direction. The third document end detector 43c detects the variation points between the brightness data of the pressure plate and the brightness data of the document background part before scanning the document part as the document end. The multifunction peripheral 1 stores an average value of scanned data of brightness of the pressure plate without dusts or blot at factory shipment etc. for example as a reference for calculating the color difference by the third document end detector 43c. Here in FIG. 9A, it is assumed that the color information of the pressure plate (data that converts RGB into Lab) is L=92, a=2, and b=−12. The third document end detector 43c calculates the color information of the document area by averaging pixel data after the variation point.

If it is assumed that the color information at the detection point A is L=88, a=−1, and b=3, the third document end detector 43c calculates the color difference Δ as follows.

ΔE=√((92−88)̂2+(2−(−1))̂2+(−12−2)̂2)=15

In addition, if it is assumed that the color information at the detection point B is L=87, a=−2, and b=3, the third document end detector 43c calculates the color difference Δ as follows.

ΔE=√((92−87)̂2+(2−(−2))̂2+(−12−3)̂2)=16

In addition, the third document end detector 43c calculates the variation point by binarizing the color information of the scanned image data using the variation point detection threshold (10 in this embodiment).

That is, as shown in FIG. 9B, the third document end detector 43c detects the variation point where the binarized value changes from 0 into 255 as the document end. In FIG. 9B, the third document end detector 43c detects ya as 111th line as the detection position A and yb as 120th line as the detection position B and outputs the detection results to the third document skew calculator 45c.

The third document skew calculator 45c calculates the third document skew d2 from the document end positions ya and yb at the detection positions A and B by the third document end detector 43c and the number of pixels ABs between the detection positions A and B using Equation (3) shown below. If it is assumed that ya is 111, yb is 125, and ABs is 2362, the second document skew d2 is calculated as about 0.34 degrees using Equation (3).

d3=(ya−yb)/Abs

d3=(111−125)/2362=about 0.34 degrees Equation (3)

The third document skew calculator 45c outputs the calculated third document skew d3 to the final document skew calculator 47.

The third acceptability calculator 44c calculates acceptability of the document end detection method using the color difference by the third document end detector 43c as a ratio between color difference between the pressure plate area and the document area and a predetermined reference edge level. In detecting the document edge using the color difference, it is possible to detect the document edge as the brightness difference gets larger. If the color information of the pressure plate is similar to the color information of the document background area, it is possible to detect the document edge wrongly since the color difference is small.

For example, if it is assumed that the reference color difference is 13 and the color difference of the document background area at the detection position A is 15, the third acceptability calculator 44c in this embodiment calculates the acceptability sa as 15/13 equals about 1.15. Similarly, if it is assumed that the color difference of the document background area at the detection position B is 16, the third acceptability calculator 44c calculates sb as 16/13 equals about 1.23.

The third acceptability calculator 44c outputs the calculated acceptability sa and sb to the third weighting factor calculator 46c.

The third weighting factor calculator 46c converts the acceptability input from the third acceptability calculator 44c into the weighting factor and outputs it to the final document skew calculator 47. More specifically, the third weighting factor calculator 46c calculates the weighting factor K3 using a simple average between the acceptability at the detection positions A and B, smaller one or larger one between the acceptability at the detection position A and the acceptability at the detection position B, or an average of the acceptability at the detection positions A and B multiplying a predetermined multiple.

For example, in case of using the simple average, the third weighting factor calculator 46c calculates K3 as (sa+sb)/2. In case of using the smaller one or the larger one, the third weighting factor calculator 46c calculates K3 as max(sa, sb) or min(sa, sb). In case of using the multiplied average, the third weighting factor calculator 46c calculates K3 as (sa*s+sb*s)/2.

Here, in case of using the multiplied average, if it is assumed that sa is 1.15, sb is 1.23, and s is 1.5, the weighting factor K3 is calculated as (1.15*1.5+1.23*1.5)/2 equals 1.785.

If the difference against a document background part is extremely large compared to the reference, it is possible that the third weighting factor calculator 46c saturates the weighting factor at a predetermined value limiting an upper value to prevent from weighting too much.

For example, in case of the upper limit of the acceptability is 1.10, the third weighting factor calculator 46c replaces 1.23 in the above example with 1.10.

By contrast, if the acceptability is extremely small, it is possible to detect wrongly. Therefore, the third weighting factor calculator 46c preset the lower limit of the acceptability and set the factor for 0 if the factor becomes smaller than the lower limit to minimize effectiveness of the wrong detection. For example, if it is assumed that sa is 1.2, sb is 0.8, and the lower limit is 0.8, the third weighting factor calculator 46c sets 0 for the weighting factor K3.

Next, the final document skew calculator 47 calculates the final document skew d based on the first document skew d1, the second document skew d2, the third document skew d3, and the weighting factors K1, K2, and K3 input from the weighting factor calculators 46a to 46c.

That is, as shown in Equation (4), the final document skew calculator 47 multiplies the first document skew d1 by the weighting factor K1, multiplies the second document skew d2 by the weighting factor K2, and multiplies the third document skew d3 by the weighting factor K3. After summing up those multiplication results, the final document skew calculator 47 divides the sum up by a sum up of all weighting factors to get the final document skew d.

d=(d1*K1+d2*K2+d3*K3)/(K1+K2+K3) Equation (4)

Subsequently, the final document skew calculator 47 outputs the calculated final document skew d to the skew corrector 48.

The skew corrector 48 corrects skew of the scanned image data by rotating the scanned image data based on the final document skew d. For example, as shown in FIG. 4D, the skew corrector 48 corrects the skew of the scanned image data in FIG. 4A by rotating the scanned image data by the final document skew d. After that, the skew corrector 48 clips the scanned image area Gr only.

More specifically, the multifunction peripheral 1 performs the detecting/correcting process above as described below. For example, regarding the brightness data generated by the first detection data generator 42a, the first document skew calculator 45a calculates the first document skew d1 as −16/2362 (about 0.39 degrees), the first acceptability calculator 44a calculates the acceptability sa as 1.15 and sb as 1.23, and the first weighting factor calculator 46a calculates the weighting factor K1 as 1.09. Regarding the brightness data generated by the second detection data generator 42b, the second document skew calculator 45b calculates the second document skew d2 as −15/2362 (about 0.36 degrees), the second acceptability calculator 44b calculates the acceptability sa as 1.30 and sb as 1.45, and the second weighting factor calculator 46b calculates the weighting factor K2 as 1.375. Lastly, regarding the color difference data generated by the third detection data generator 42c, the third document skew calculator 45c calculates the third document skew d3 as −14/2362 (about 0.34 degrees), the third acceptability calculator 44c calculates the acceptability sa as 1.15 and sb as 1.23, and the third weighting factor calculator 46c calculates the weighting factor K3 as 1.19.

In this case, the final document skew calculator 47 calculates the final document skew d as follows using Equation (4).

d=((−16/2362)*1.09+(−15/2362)*1.375+(−14/2362)*1.19)/(1.09+1.375+1.19)=−0.00634 (about 0.36 degrees)

In case of using weighted average as described above, for example, if the weighted average does not use the detection result that includes the acceptability equal to or less than 1.1, the result is calculated as follows.

That is, in this case, since the acceptability sb calculated by the first acceptability calculator 44a is equal to 1.07 and less than 1.1, the final document skew is calculated as follows excluding the first document skew d1 that includes the acceptability sb from the calculation target of the final document skew d.

d=((−15/2362)*1.375+(−14/2362)*1.19)/(1.375+1.19)=−0.00615

Subsequently, in the multifunction peripheral 1, the skew corrector 48 corrects the scanned image data based on the calculated final document skew d, and the final document skew calculator 47 stores the final document skew d in the memory such as the NVRAM 24 etc.

The multifunction peripheral 1 configures an skew discard condition that all acceptability calculated by all detection methods are less than a predetermined lower limit value. In this case, if the acceptability is less than the lower limit value, the final document skew d calculated in the previous detecting/correcting skew process is used.

For example, if the skew discard condition is set to 0.8 preliminarily and the acceptability in the skew detecting/correcting process for the next page are calculated as shown below, the final document skew calculator 47 adopts the previous final document skew d acquired in the previous skew detecting/correcting process and stored.

The acceptability sa and sb calculated by the first acceptability calculator 44a are 0.75 and 0.79. The acceptability sa and sb calculated by the second acceptability calculator 44b are 0.65 and 0.78. The acceptability sa and sb calculated by the third acceptability calculator 44c are 0.3 and 0.5. In this case, it is not limited that the final document skew calculator 47 uses the previous final document skew d. For example, it is possible to adopt a final document skew (e.g., 0) preset as default.

In this case, it is possible that the final document skew calculator 47 notifies of information that the previous final document skew is adopted or the default final document skew is adopted etc. by displaying the information on the display unit 8b on the control panel 8.

Accordingly, it is possible to notify of the skew angle used for correcting the scanned image data clearly, and it is possible to improve the usability.

As described above, the multifunction peripheral 1 in this embodiment includes a data receiver (a data receiving unit) 40 that receives scanned image data acquired by scanning an image on a document, a plurality of document end detectors (document end detecting unit) 43a to 43c that detects an end of the document in the scanned image data using different end detection methods and different detection conditions with the same end detection method, document skew calculators (skew calculating units for each method) 45a to 45c that calculates skew of the scanned image data separately based on the end data for each method and outputs skew data for each method, and a final document skew calculator (skew calculating unit) 47 that calculates skew of the scanned image data based on the skew data for each method.

As a result, it is possible to reduce effect of dusts and vertical streaks etc. and determine the document skew precisely.

In addition, the multifunction peripheral 1 in this embodiment further includes a skew corrector (a skew correcting unit) 48 that corrects skew of the scanned image data based on the skew data.

Accordingly, it is possible to correct the skew of the scanned image data based on the document skew detected precisely and utilize the scanned image data effectively.

Furthermore, the multifunction peripheral 1 in this embodiment further includes detection data generators (data generating units) 42a to 42c that generate data to be processed for each method suitable for the end detection method or the detection condition of each of the document end detectors (document end detecting units) 43a to 43c. The document end detectors 43a to 43c detect the document end based on the data to be processed for each method and output the end data for each method.

Accordingly, it is possible to detect the document end in the scanned image data appropriately depending on various end detection methods and the detection condition, and it is possible to reduce effect of dusts and vertical streaks etc. and determine the document skew precisely much more.

In addition, the multifunction peripheral 1 in this embodiment further includes acceptability calculators (acceptability calculating units) 44a to 44c that calculates acceptability of document end detection in the end detection methods of each of the document end detectors (document end detecting units) 43a to 43c and weighting factor calculators (weighting factor calculating units) 46a to 46c that calculates weighting factors for each method corresponding to skew data for each method using the acceptability. The final document skew calculator (skew calculating unit) 47 calculates skew of the scanned image data based on the skew data for each method and the weighting factors for each method.

Accordingly, it is possible to detect the document end in the scanned image data appropriately much more depending on various end detection methods and the detection condition, and it is possible to reduce effect of dusts and vertical streaks etc. much more and determine the document skew precisely much more.

Furthermore, in the multifunction peripheral 1 in this embodiment, any one of the end detection methods used by any one of the document end detectors (document end detecting units) 43a to 43c is an edge extracting end detection method that detects the document end based on an edge extracting level, and the acceptability calculators (acceptability calculating units) 44a to 44c calculate a ratio between a predetermined reference edge level and a peak level of an edge extracting level of the scanned image data as acceptability in the edge extracting end detection method.

Accordingly, it is possible to detect the document end precisely by extracting the edge, and it is possible to reduce effect of dusts and vertical streaks etc. much more and determine the document skew precisely much more.

In addition, in the multifunction peripheral 1 in this embodiment, any one of the end detection methods used by any one of the document end detectors (document end detecting units) 43a to 43c is a density difference end detection method that detects the document end based on density difference in image data, and the acceptability calculators (acceptability calculating units) 44a to 44c calculate a ratio between a predetermined reference density difference and density difference between inside of the document area and the outside of the document area as acceptability in the density difference end detection method.

Accordingly, it is possible to detect the document end precisely by using the density difference, and it is possible to reduce effect of dusts and vertical streaks etc. much more and determine the document skew precisely much more.

In addition, in the multifunction peripheral 1 in this embodiment, one end detection method used by one of the document end detectors (document end detecting units) 43a to 43c is a color difference end detection method that detects the document end based on color difference in image data, and the acceptability calculators (acceptability calculating units) 44a to 44c calculate a ratio between a predetermined reference color difference and density difference between inside of the document area and the outside of the document area as acceptability in the color difference end detection method.

Accordingly, it is possible to detect the document end precisely by using the color difference, and it is possible to reduce effect of dusts and vertical streaks etc. much more and determine the document skew precisely much more.

In addition, in the multifunction peripheral 1 in this embodiment, the weighting factor calculators (weighting factor calculating units) 46a to 46c calculate the weighting factor for each method using either one of a simple average between the acceptability at the detection positions detected by the document end detectors (document end detecting units) 43a to 43c, maximum one or minimum one between the acceptability, and a weighted average of the acceptability multiplying contribution ratios in accordance with the end detection method or the detection condition.

Accordingly, it is possible to adjust the detection result by each end detection method appropriately and improve detection precision of the document skew. As a result, it is possible to reduce effect of dusts and vertical streaks etc. much more and determine the document skew precisely much more.

Furthermore, in the multifunction peripheral 1 in this embodiment, the weighting factor calculators (weighting factor calculating units) 46a to 46c calculates the acceptability as the weighting factors for each method by saturating the upper limit of the acceptability and the lower limit of the acceptability.

Accordingly, it is possible to process the irregular end detection result appropriately and improve detection precision of the document skew. As a result, it is possible to reduce effect of dusts and vertical streaks etc. much more and determine the document skew precisely much more.

In addition, in the multifunction peripheral 1 in this embodiment, if the acceptability becomes smaller than a predetermined lower limit value, the weighting factor calculators (weighting factor calculating units) 46a to 46c calculates specified acceptability that specifies the previous document skew as the skew or specifies a predetermined document skew as the skew as the weighting factor for each method. If the weighting factor calculators 46a to 46c specify the specified acceptability as the weighting factor for each method, the final document skew calculator (skew calculating unit) 47 outputs the skew data considering the previous document skew or the configured document skew as skew of the scanned image data.

Accordingly, it is possible to process the irregular end detection result appropriately and improve detection precision of the document skew. As a result, it is possible to reduce effect of dusts and vertical streaks etc. much more and determine the document skew precisely much more.

Furthermore, the multifunction peripheral 1 in this embodiment further includes a display (reporting unit) 8b on the control panel 8 that reports information. If the final document skew calculator (skew calculating unit) 47 outputs the skew data considering either the previous document skew or the configured document skew as skew of the scanned image, a message indicating that is displayed on the display 8b.

Accordingly, it is possible to report the skew angle used for correcting the scanned image data clearly, and it is possible to enhance the usability.

In addition, the multifunction peripheral 1 in this embodiment detects document end in the scanned image data desired to detect upper ends of the document at two points only.

Accordingly, it is possible to detect the document end quickly and reasonably.

Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits. A processing circuit includes a programmed processor. A processing circuit also includes devices such as an application specific integrated circuit (ASIC) and conventional circuit components arranged to perform the recited functions.

What is claimed is:

1. An image processing apparatus, comprising:
a data receiver to receive scanned image data acquired by scanning an image on a document;
a plurality of document end detectors to detect an end of the document in the scanned image data using either different end detection methods or the same end detection method under different detection conditions to output end data for each detection method;
a first skew calculator for each detection method to calculate skew of the scanned image data separately based on the end data for each detection method to output skew data for each method; and
a second skew calculator to calculate skew of the scanned image data based on the skew data for each detection method.

2. The image processing apparatus according to claim 1, further comprising a skew corrector to correct skew of the scanned image data based on the skew data.

3. The image processing apparatus according to claim 1, further comprising a data generator to generate data to be processed for each method suitable for the end detection method or the detection conditions of each of the document end detectors from the scanned image data,
wherein the document end detector detects the document end based on the data to be processed for each method and outputs the end data for each method.

4. The image processing apparatus according to claim 1, further comprising:
an acceptability calculator to calculate acceptability of document end detection in the end detection method of each of the document end detectors; and
a weighting factor calculator to calculate a weighting factor for each method corresponding to skew data for each method using the acceptability,
wherein the second skew calculator calculates the skew of the scanned image data based on the skew data for each method and the weighting factor for each method.

5. The image processing apparatus according to claim 4, wherein any one of the end detection methods used by any one of the document end detectors is an edge extracting end detection method that detects the document end based on an edge extracting level, and the acceptability calculator calculates a ratio between a predetermined reference edge level and a peak level of an edge extracting level of the scanned image data as acceptability in the edge extracting end detection method.

6. The image processing apparatus according to claim 4, wherein any one of the end detection methods used by any one of the document end detectors is a density difference end detection method that detects the document end based on density difference in image data, and the acceptability calculator calculates a ratio between a predetermined reference density difference and a density difference between inside of the document area and the outside of the document area as acceptability in the density difference end detection method.

7. The image processing apparatus according to claim 4, wherein any one of the end detection methods used by any one of the document end detectors is a color difference end detection method that detects the document end based on color difference in image data, and the acceptability calculator calculates a ratio between a predetermined reference color difference and a density difference between inside of the document area and the outside of the document area as acceptability in the color difference end detection method.

8. The image processing apparatus according to claim 4, wherein the weighting factor calculator calculates the weighting factor for each method using either a simple average of the acceptability at the detection positions detected by the document end detector, a maximum value, and a minimum value of the acceptability, and a weighted average of the acceptability multiplying a contribution ratio in accordance with the end detection method or the detection conditions.

9. The image processing apparatus according to claim 4, wherein the weighting factor calculator calculates the acceptability as the weighting factor for each method by saturating an upper limit of the acceptability and a lower limit of the acceptability.

10. The image processing apparatus according to claim 4, wherein the weighting factor calculator calculates specified acceptability that specifies a previous document skew as the skew or specifies a predetermined document skew as the skew as the weighting factor for each method if the acceptability becomes smaller than a predetermined lower limit value, and the skew calculator outputs the skew data considering either the previous document skew or the predetermined document skew as skew of the scanned image data if the weighting factor calculator specifies the specified acceptability as the weighting factor for each method.

11. The image processing apparatus according to claim 10, further comprising a reporting unit that reports that either the previous document skew or the predetermined document skew is output as skew of the scanned image,
wherein the second skew calculator instructs the reporting unit to report if the skew calculator outputs the skew data considering either the previous document skew or the predetermined document skew as the skew of the scanned image.

12. An image scanner comprising:
an image reader to read the image on the document into the scanned image data; and
the image processing apparatus according to claim 1 to detect and correct skew of the scanned image data of the document.

13. A method of processing an image, comprising the steps of:
receiving scanned image data acquired by scanning an image on a document;
detecting an end of the document in the scanned image data using either different end detection methods or the same end detection method under different detection conditions to output end data for each detection method;
calculating skew of the scanned image data separately based on the end data for each method and outputting skew data for each method; and
calculating skew of the scanned image data based on the skew data for each method.

14. A non-transitory, computer-readable recording medium storing a program that, when executed by a processor, causes the processor to implement a method of processing an image, comprising the steps of:
receiving scanned image data acquired by scanning an image on a document;
detecting an end of the document in the scanned image data using either different end detection methods or the same end detection method under different detection conditions to output end data for each detection method;
calculating skew of the scanned image data separately based on the end data for each method and outputting skew data for each method; and
calculating skew of the scanned image data based on the skew data for each method.
